(19) United States
(12) Patent Application Publication
(10) Pub. No.: US 2009/0237417 A1
(43) Pub. Date: Sep. 24, 2009

(54) Apparatus and method for image manipulations for games

(75) Inventor: Dror Gadot, Ramat-Gan (IL)

Correspondence Address: MARTIN D. MOYNIHAN d/b/a PRTSI, INC., P.O. BOX 16446, ARLINGTON, VA, 22215, US

(73) Assignee: Samsung Electronics Co., Ltd., Gyeonggi-do (KR)

(21) Appl. No.: 11/987,359

(22) Filed: Nov. 29, 2007

(51) Int. Cl. G09G 5/37; G06K 9/34

(52) U.S. Cl. 345/629; 382/164

(57) ABSTRACT

Apparatus for image acquiring and modification, comprises: an image acquiring unit for acquiring an image, an image localized modification unit to make a modification to the acquired image in real time at a given locality in the image, a modification storage register for automatically storing the locality, and an interaction unit for displaying the image to a user. The interaction unit includes pointing interactivity for allowing a user to point to a location on the image, and an indicator to indicate to a user when the location pointed to coincides with the locality of the image modification.

### FIELD AND BACKGROUND OF THE INVENTION

The present invention, in some embodiments thereof, relates to apparatus and a method for image manipulations for example for use in games and, more particularly, but not exclusively, to such image manipulations for games played on a mobile telephone or other camera-equipped computing device.

Reference is now made to FIGS. 1A and 1B which are two versions of a single photograph showing the outlines of people standing in front of a viewing port through which dolphins and other aquatic creatures can be seen. The photograph has been manipulated using image editing packages so that there are differences between the two images. The user is invited to spot the differences.

The spot the difference game is a game that tests the user's powers of observations to find small differences between two given pictures. The difficulty level of the game is set according to the size of the changed item or items and the similarity in color it has with its background.

Numerous examples of spot the difference games are known from printed publications and on the Internet.

Some sites on the web provide versions of the spot the differences game, but all of them use fixed content. The pairs of images used are manipulated in advance via manual intervention. A single user cannot both provide and manipulate the content and also play the game, since, if he manipulated the image then there is no challenge in finding where the manipulations are located.

### SUMMARY OF THE INVENTION

The present embodiments provide a way of allowing a user to provide his own content in a spot the difference game that he can join in himself.

Examples are given of real time automatic image manipulation of self-generated content, so that the user of a mobile telephone or the like can provide his own spot the difference game.

According to one aspect of the present invention there is provided apparatus for image acquiring and modification, comprising:

an image acquiring unit for acquiring an image,

an image localized modification unit configured to make a modification to said acquired image in real time at a given locality,

a modification storage unit, associated with said image localized modification unit, for automatically storing said locality, and

an interaction unit associated with said modification storage register, configured for displaying said image to a user, said interaction unit including pointing interactivity for allowing a user to point to a location on said image, said interaction unit further comprising an indicator to indicate to a user when said location coincides with said locality.

In an embodiment, said image localized modification unit is configured to make said modification after said acquiring and prior to said displaying.

In an embodiment, said modification comprises making an addition to said image at said given locality.

In an embodiment, said modification comprises making a subtraction from said image at said given locality.

In an embodiment, said modification comprises replacement of said subtraction with a continuation of a background.

In an embodiment, said modification is applied to an object within said image.

An embodiment may comprise an object identifier for identifying objects within said image as candidates for said modification.

In an embodiment, said object identifier is associated with a movement detector, said movement detector being configured to use movement detection to prefer relatively stationary objects as targets for said modification.

In an embodiment, said object identifier is configured to detect boundaries within said image and from said boundaries to infer an object from any closed boundary.

In an embodiment, said object identifier is configured to infer a boundary from substantial color changes between pixels.

In an embodiment, said modification is carried out in accordance with input from a user.

An embodiment may comprise a background analyzer, associated with said object identifier, to distinguish those objects lying over a relatively uniform background as preferred candidates for said modification.

An embodiment may comprise a background analyzer for analyzing a background against which said addition is made, thereby to allow said addition to merge into said background.

An embodiment may be a mobile communication device wherein said image acquiring unit comprises a built-in camera.

In an embodiment, said interaction unit comprises a message sending unit for sending said modified image to other users.

In an embodiment, said interaction unit is configured to show both said modified image and an unmodified original.

In an embodiment, said interaction unit is configured to assign a user a score based on a number of modifications identified.

In an embodiment, said interaction unit is configured to assign a score based on a time taken to identify modifications.

In an embodiment, said interaction unit is configured to retain a connection with another unit to which said image was sent, thereby to enable competition between users.

In an embodiment, said interaction unit is configured to obtain from a user a number of modifications to be made.

According to a second aspect of the present invention there is provided a method for image acquiring and modification, comprising:

acquiring an image,

making a modification to said acquired image in real time at a given locality,

storing said locality,

displaying said image to a user,

allowing a user to point to a location on said image,

indicating to a user when said locality coincides with said location.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A and 1B are examples of successively manipulated versions of a single photograph according to the prior art, for playing spot the difference;

FIG. 2 is a simplified block diagram illustrating a device for image manipulation and interaction in real time according to a first embodiment of the present invention;

FIG. 3 is a simplified block diagram illustrating a device for object identification and selection for removal, according to an embodiment of the present invention;

FIG. 4 is a simplified block diagram illustrating a device for object addition in accordance with one embodiment of the present invention;

FIG. 5 is a simplified flow chart illustrating a method for modifying and interacting with an image in real time according to a preferred embodiment of the present invention;

FIG. 6 is a simplified flow chart illustrating the method of FIG. 5 from the user point of view;

FIG. 7 is a photograph to which object identification in accordance with the present embodiments is applied in the following figure;

FIG. 8 is a vector image showing boundaries around suspected objects of the photograph of FIG. 7;

FIG. 9 is a photograph in which a potential object for removal has been identified in accordance with preferred embodiments of the present invention;

FIG. 10 illustrates the photograph in FIG. 9 where the object pointed out therein has been removed and replaced with a plain black background;

FIG. 11 is the photograph of FIG. 9 in which a different object has been selected for removal;

FIG. 12 is a detail around the object selected for removal in FIG. 11;

FIG. 13 is a color histogram generated from, and used to analyze, the background of the object in FIG. 12;

FIG. 14 shows vector based analysis of the object with its background, in accordance with an embodiment of the present invention;

FIG. 15 shows a photograph to which an object is inserted as the image manipulation;

FIG. 16 is a simplified flow chart illustrating a technique for image manipulation by object subtraction according to an embodiment of the present invention; and

FIG. 17 is a simplified flow chart illustrating object identification for the object subtraction technique of FIG. 16.

### DESCRIPTION OF EMBODIMENTS OF THE INVENTION

The present invention, in some embodiments thereof, relates to apparatus and a method for image manipulations for example for use in games and, more particularly, but not exclusively, to such image manipulations for games played on a mobile telephone or other camera-equipped computing device.

The present embodiments provide direct manipulation of captured image content. In one version the user compares a captured and manipulated image with his view of the environment from which the image was captured. The user may indicate that he or she has spotted the manipulation by pointing to the manipulation in the image on screen. In another version manipulated and non-manipulated images are provided to one or more users who compete with each other to spot the manipulations.

The manipulations may include additions or deletions or other manipulations of objects within the image. Deletions may be replaced with continuations of the local background and additions may be made to merge into the local background so as to be difficult to spot. Different levels of manipulations may be provided, from relatively easy to spot for younger users to relatively difficult for older and more sophisticated users.

The manipulation unit may be set to use movement detection to avoid making changes to moving objects, so that comparing the image with the environment remains valid for as long as possible.

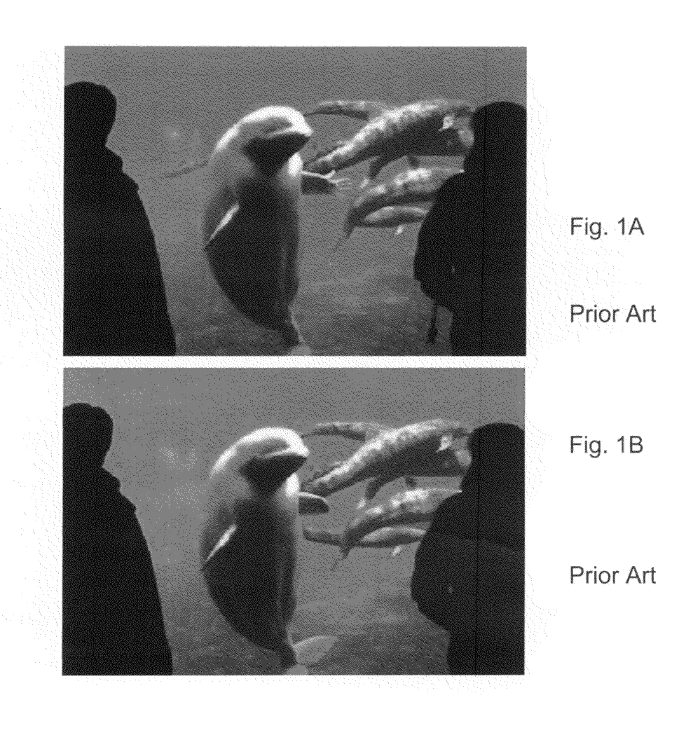

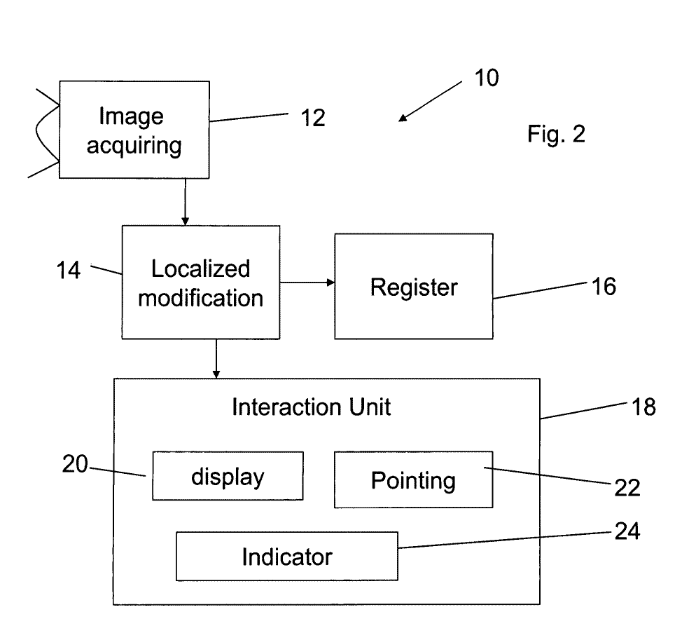

For purposes of better understanding some embodiments of the present invention, as illustrated in FIGS. 2-15 of the drawings, reference has already been made to the construction and operation of conventional spot the difference image pairs as illustrated in FIGS. 1A and 1B. These figures illustrate two versions of an original photograph, to which three manipulations have been carried out. The manipulations were carried out by hand by a user off-line using image editing software. Clearly off-line processing is not practical on a platform such as a mobile telephone, and such procedures could never be used to allow a user to guess changes between the image and the current environment since the environment will have changed by the time the off-line processing is available. Furthermore, as the user has made the changes using off-line processing there is little point in him or her guessing what the changes are.

Using the present embodiments however the manipulations to the images may now be made both on line and automatically, using image processing techniques at the mobile telephone. Thus the user can guess changes based on his own content and can have the results ready in time to compare with the environment from which the image was captured.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Reference is now made to FIG. 2, which is a simplified block diagram illustrating image acquiring and modification apparatus according to a first preferred embodiment of the present invention. Apparatus 10 comprises an image acquiring unit 12 which acquires images. Typically, image acquiring unit 12 is a camera and acquires images from the environment, however the acquiring unit may alternatively acquire images from an archive, or from over a communication network, and from sources including still images and video.

Connected after the image acquiring unit is a localized modification unit 14. The image localized modification unit makes a modification to the acquired image in real time at a given locality, using techniques that are discussed in greater detail below.

A modification storage register unit 16, is connected to the localized modification unit 14, and stores the locality in which the modification was made, typically in terms of pixel coordinates. Storage is typically automatic. In one embodiment the location is stored as metadata alongside or within the image file. In another embodiment the location is stored as a number in a location in electronic memory. In one embodiment storage includes storing of the pixels prior to the manipulation as well.

An interaction unit 18 is located after the localized modification unit 14 and storage register 16. The interaction unit includes a display manager 20 to display the modified image to a user, for example using the screen of the mobile telephone on which the image was acquired. The interaction unit may include a pointing manager 22 for managing interactive pointing through the display. The user points to a location on the image. Indicator 24 then indicates to a user when the location pointed to coincides with the locality in which the modification was made.

It is noted that the image localized modification unit 14 includes the ability to make the modification after the image is acquired but prior to the image being displayed. This differs from prior art systems where the image must be displayed at the time the modifications are being made.

The localized image modification may be an addition applied to the image, or it may be a subtraction from the image or it may be a distortion or transformation or any other modification to a locality within the image, including changing the color or texture at that location.

Subtractions are typically complemented with replacement using a continuation of the local background. In this way objects may be made to apparently disappear.

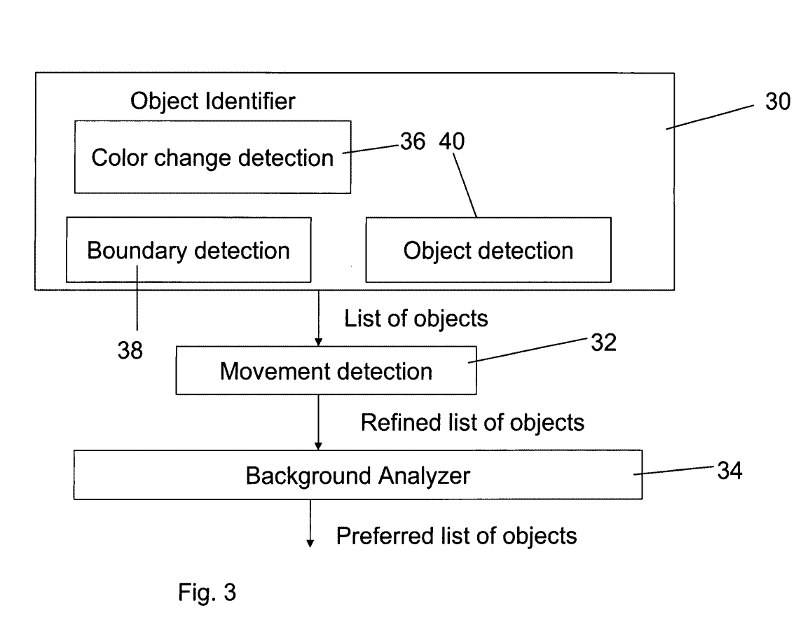

In accordance with embodiments of the invention, modifications are applied to objects located within the image. Reference is now made to FIG. 3 which shows part of the localized image modification unit of FIG. 2 in a version adapted to identify objects within the image and then apply the modifications to those objects identified as being most suitable therefor.

In FIG. 3, an object identifier 30 carries out identification of objects within the image to provide an initial list of candidates for the modification.

Connected downstream of the object identifier is a movement detector 32 which cuts down the list of candidates in such a way as to prefer relatively stationary objects as targets for the modification. Basic movement detection may be implemented simply by capturing successive images, identifying the corresponding objects and seeing if their locations have changed.

Connected downstream of the movement detector is a background analyzer 34 which analyzes the background around the objects in the list. Those objects set in front of a smooth background are preferred over those objects over a complex background since it is easier to mimic a smooth background when deleting an object.

Returning to the object identifier itself and one method of object detection that can be used involves a color change detector 36 connected to a boundary detector 38. First of all locations of color change are detected. Boundaries are drawn to define continuities in these color change regions and then the object detection unit 40 infers an object from any closed boundary.

The background analyzer 34 distinguishes those objects lying over a relatively uniform background as preferred candidates for modification. More particularly, any object that is to be deleted needs to be replaced by a continuation of its background. A uniform background is easier to replace than a variegated background.

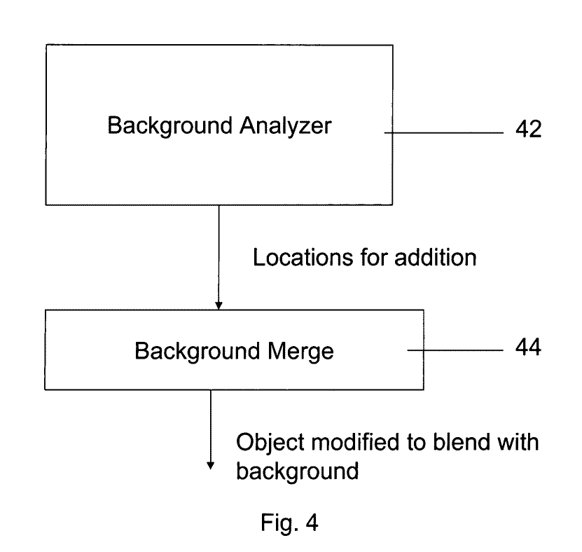

In other cases the modification may involve addition of an object into a scene. Reference is now made to FIG. 4 which shows a localized modification unit adapted for addition of an object into the image. In this case there is no need for prior identification of objects within the image. The unit comprises a background analyzer 42 which analyzes particular areas of background of the object, and a background merge unit 44 which then merges an object into the analyzed background at varying levels of inconspicuousness.

In a variation, instead of the modification being entirely automatic, the user may provide input to affect the modification. For example the user may be shown candidate objects with markings and may select which marked objects he wishes to remove. Alternatively the user may be asked to enter a number of desired modifications. As a further alternative the user may be asked to choose between additions, subtractions and distortions. Facial features may for example be distorted.

As mentioned, the above embodiments may be incorporated into a mobile telephone. Mobile telephones are able to communicate images and the interaction unit may further include a communication manager for sending modified images to other users together with the modification location data, and perhaps even with the unmodified images.

A remotely located user may then display the original and modified images on his screen and likewise attempt to point to the locality at which the modification or modifications were made.

It will be appreciated that the two images may be shown together on the screen or one after the other. The skilled person will appreciate that if shown in sequence the second image should not appear immediately after the first image disappears as otherwise the eye's sensitivity to apparent movement will pick out the changes.

The interaction unit may assign a user a score based on a number of modifications identified.

The interaction unit may assign a score based on a time taken to identify modifications.

The interaction unit may manage or retain a connection with another unit to which the image was sent, so that two users can play against each other, allowing one to be declared the winner.

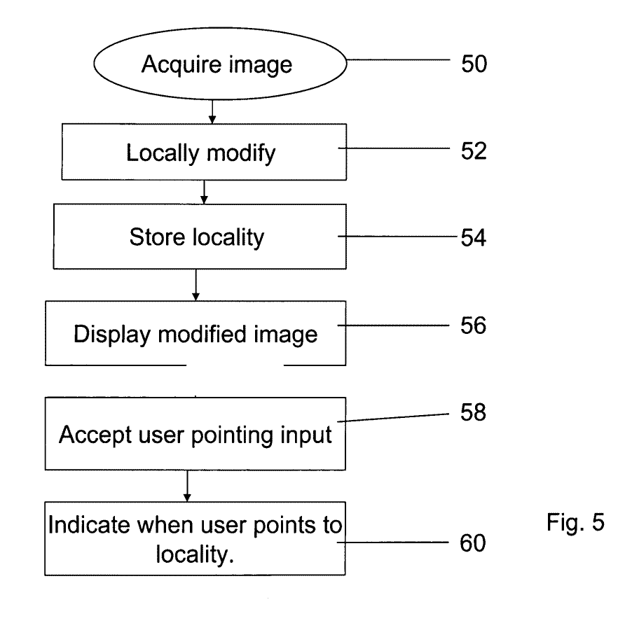

Reference is now made to FIG. 5, which is a simplified flow chart illustrating a method for image acquiring and modification according to the present embodiments. The method comprises 50 acquiring an image, 52 making a modification to the acquired image in real time at a given locality, 54 storing the locality, 56 displaying the modified image to a user, 58 allowing a user to point to a location on the image, and 60 indicating to a user when the locality of the modification coincides with the location being pointed to.

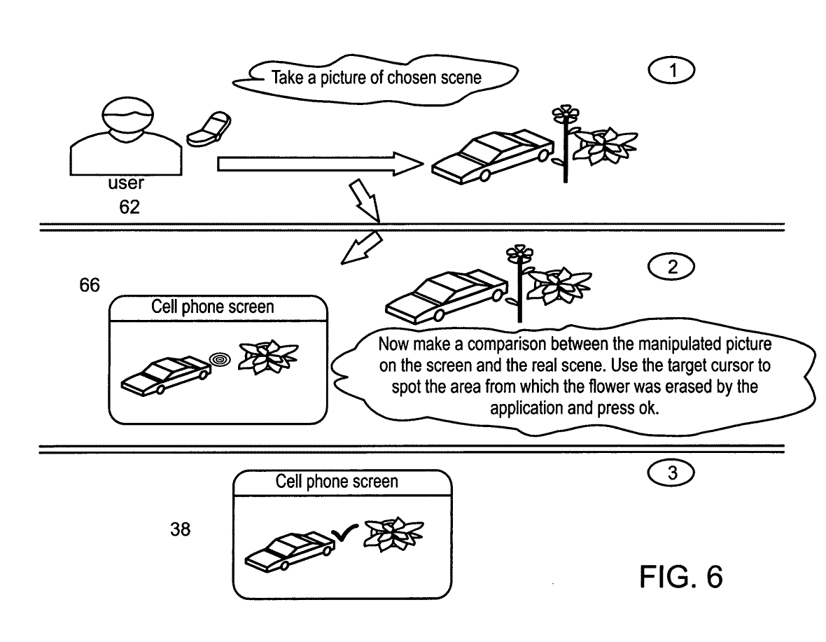

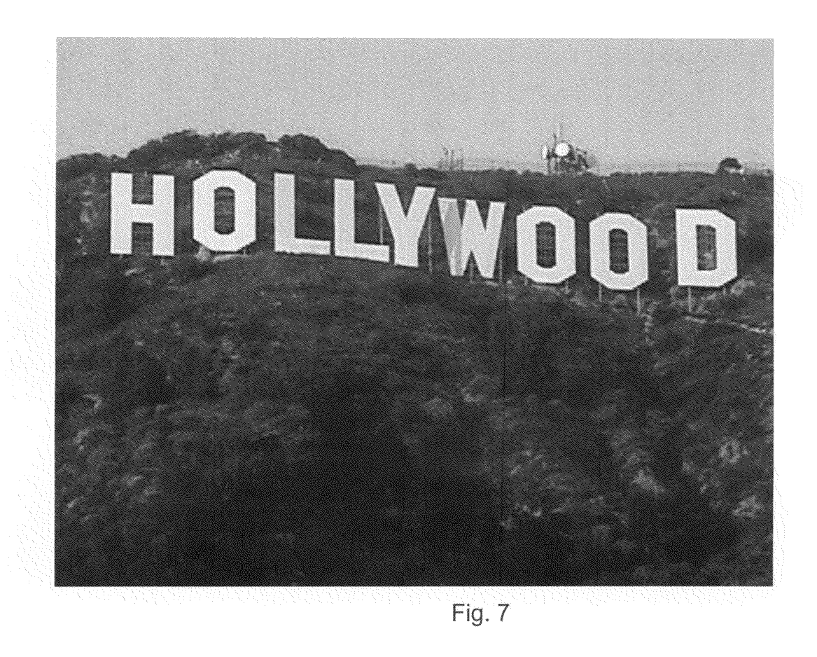

Reference is now made to FIG. 6, which is a user's eye view of the process outlined above according to one of the embodiments of the present invention. The user 62 wishes to play a mobile phone realistic version of the “spot the differences” game, and to do so he uses the camera of his mobile phone 64, to take a picture of a scene he chooses from real life. The phone then automatically uses a picture processing algorithm, as described above, in order to manipulate the picture in real time so that the immediate picture that the user sees 66 will already be different from the real scene it was taken from. Now, the user proceeds to spot the differences between the picture he took and reality 68.

As shown in FIG. 6, the user takes a picture of a scene using the camera of his mobile phone. After a few seconds he sees a picture on his screen that looks like the real picture he has taken, but in fact the image processing algorithm has already manipulated the actual image the camera took. The manipulation in this example comprises subtraction, that is taking one or more objects out of the scene and restoring the assumed background behind them so that it will look as if the removed object never existed in the real scene.

As explained, an alternative option is to add a new item to the image instead of deleting an item. The new item added may be considered as the modification whose location the user is expected to identify. Addition may comprise adding a known shape or icon to the picture and may be complemented by adjusting its color according to the background it is being placed over, as explained above with respect to FIG. 4.

A small cross or arrow may now appear on the manipulated picture as a marker or cursor. Using camera motion or the phone keys, or by manipulating the cursor, the user is now able to explore the picture on the screen (panning) and determine the difference between the picture on his screen and the real scene in front of him, from which the image was taken.

Whenever the user spots a difference, he places the cursor on the locality of the difference, the location of the missing object, and presses the acceptance button. As explained, the application has saved the location of the object manipulated, and when the player hits the location, albeit with a certain tolerance allowed, the operation is counted a success. In one variation a correct click on the location may restore the modification, and in yet another variation it is also possible to emphasize the limits of the returned object by a marker, for example a red line or a thick line or the like.

The game is over when all missing objects are found. The number and size of the missing objects may be declared at the beginning of the game according to the difficulty level the user chooses, and perhaps according to progress on previous levels. As mentioned above, different levels of difficulty may be set.

As explained above, prior to subtracting objects, candidate objects need to be located and defined. Then the most suitable of the candidate objects are chosen for deletion.

Thus a first stage of the algorithm comprises identifying an object within the image and determining its borders.

An object is a part of the image, in this case in the form of a bitmap, whose colors are uniform within an agreed threshold. The threshold is calculated based upon the color histogram of the entire picture or an entire area within the picture.

The colors of the object may be different from the average color surrounding the object by a predetermined number, and the level of this predetermined number may actually set the difficulty level of the current round.

In one embodiment the image is gray scaled and noise reduction is applied. Then a map of connective components that accord with a size of objects of interest. Thus levels designed for small children would look for larger object sizes than levels for more sophisticated players. Connective components are groups of neighboring pixels that have the same color within the predetermined threshold.

Then the image may be vectorized using the following vectorization algorithm.

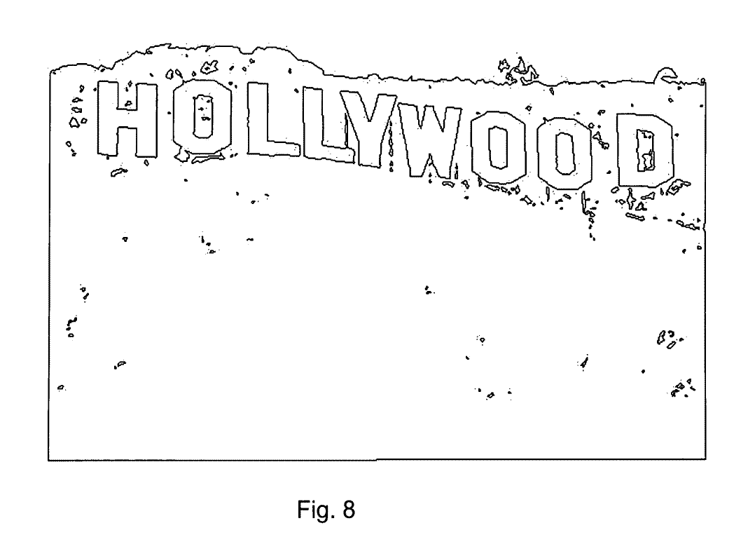

The vectorization algorithm translates a bitmap into a vector representation, the vectors are actually created according to the contrast of colors, every switch between 2 different colors may be replaced by a vector. Thus the photograph in FIG. 7 would translate into the vector map shown in FIG. 8. The algorithm now goes over to the vector representation of the picture and looks for closed contours. The area closed within the contours represent what we may call objects. In FIG. 8, each of the Hollywood letters is defined by a closed contour. Other smaller objects in the detail of the hillside are also apparent. Potentially each of the letters on the hill is suitable as an object for deletion, and would be placed on the initial list.

Once the object is defined and is assigned a clear border, one may explore its background. Analysis of the background comprises an analysis of the non-object area surrounding the object of interest. The simpler the background the easier it is to mimic once an object has been delete. Criteria to define the complexity of the background are defined according to the parameters discussed below.

If the histogram of colors of the background around the defined object shows that it contains too many colors we may decide that the background is too complex and it might be impossible to restore it behind the object we're about to remove.

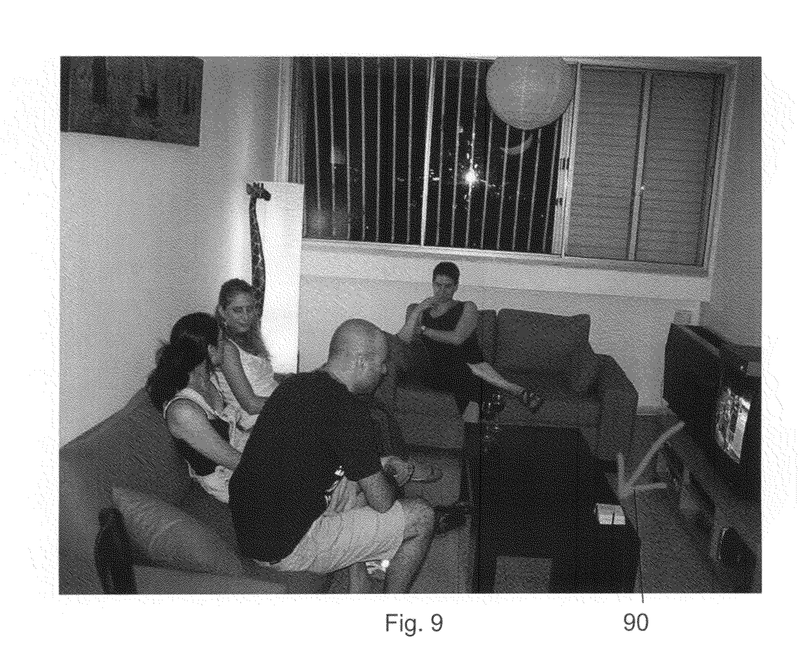

Reference is now made to FIG. 9 which shows a user-generated photograph in which an objected suggested for removal has been identified, and is indicated by arrow 90.

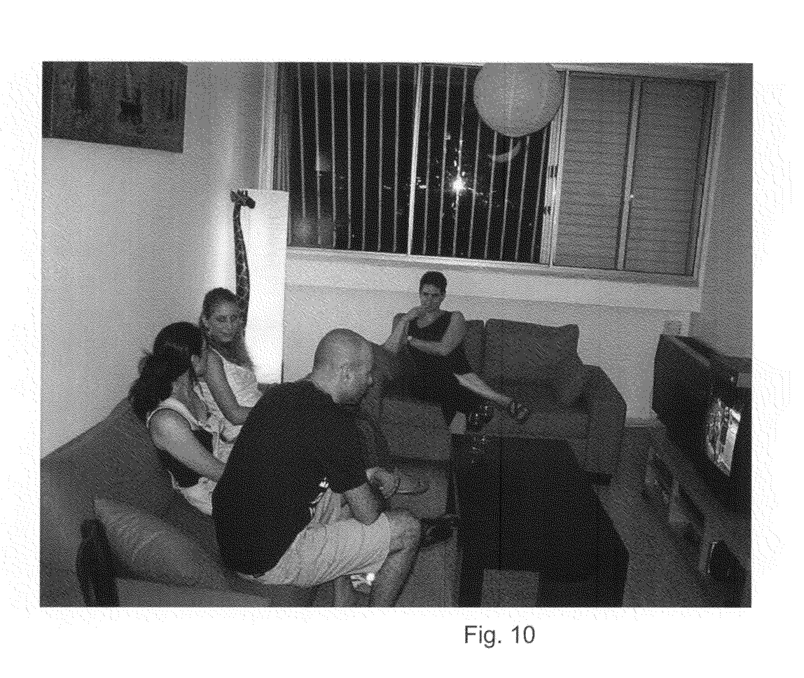

Firstly the object is defined by borders as explained. Then the algorithm checks the colors around the borders and realizes that there is a simple black background. Therefore once the algorithm removes the item spotted on the table it will be simple to replace with plain black color to mimic the background. The result is shown in FIG. 10.

A parameter for the number of colors in the surrounding background is tested because if the case is not as shown on the picture, for example if there is a colorful map or tablecloth on the table, then the result of the test would reveal the problem of a multi colored background. In such a case the algorithm may decide to give up on the initial object the algorithm has chosen and find another one instead. Trying and not fully succeeding to imitate a complicated background behind an object tends to reveal the manipulation in the image to the user.

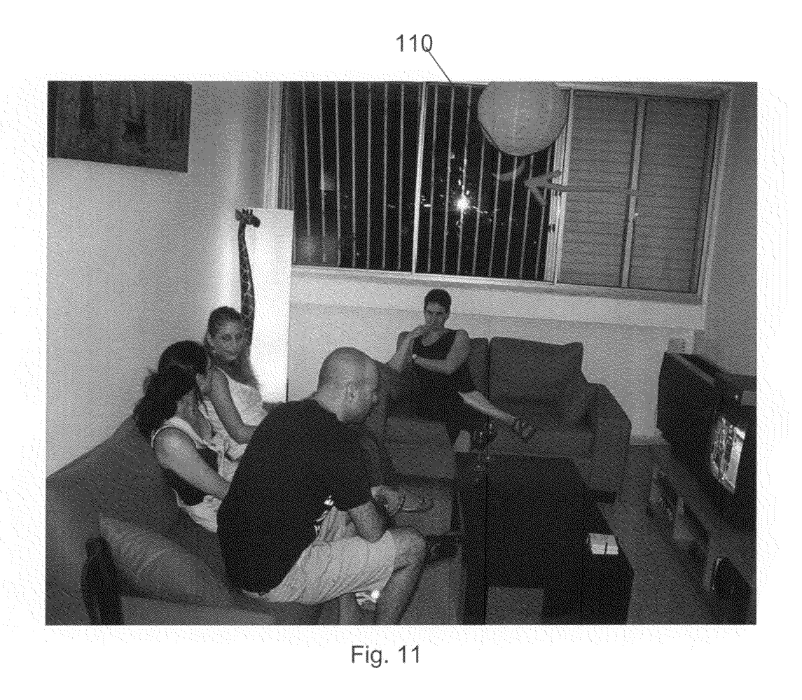

Reference is now made to FIG. 11 where the same photograph is shown but this time a different object, a crescent moon behind bars of a window, has been identified. In this case a parameter that may be considered is a number of different items on the background. While analyzing the area surrounding an item which is selected for removal, we may rate the complexity of the background. The rating need not relate to colors as such but instead as to whether identifiably different items are included in the background and may need to be restored after the object is removed.

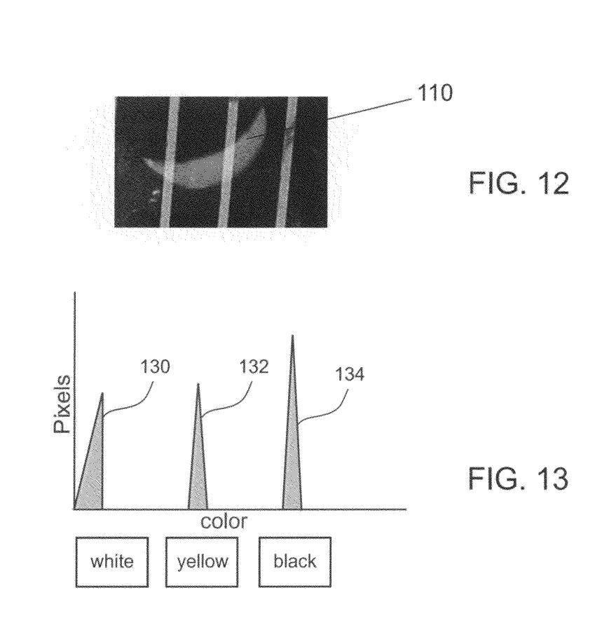

The quarter moon in the window is labeled 110. The region containing the quarter moon is shown in close up in FIG. 12.

After the algorithm has defined the moon 110 as an object nominated for removal, then the algorithm proceeds to analyze the area around the object. The object under consideration may itself be included in the analysis.

The result of the analysis is the color histogram shown in FIG. 13 where mutually isolated color peaks for white 130 yellow 132 and black 134 are shown.

The color representation here shows that there are three dominating colors at the area of the nominated object and these relate to objects or items as follows:

1. The object (moon)—shades of yellow.

2. The sky—shades of black.

3. The bars—shades of white.

The situation of two or more dominating colors aside from the object itself, as obtained here, indicates that the background is not homogenous and cannot be restored easily by using only one color.

In order to get more information regarding the background, the background area may be vectorized, as was done for finding the objects. The meaning of the vectorization process is that we no longer look at the picture as a bitmap that contains the values of the scene as pixels and their colors. Rather we take the picture through a process that will eventually carry its information as vectors, that is to say as contours. The tracing or vectorization algorithm essentially translates color changes into lines. In one version the lines may be assigned different thicknesses according to the contrast between the colors on either side.

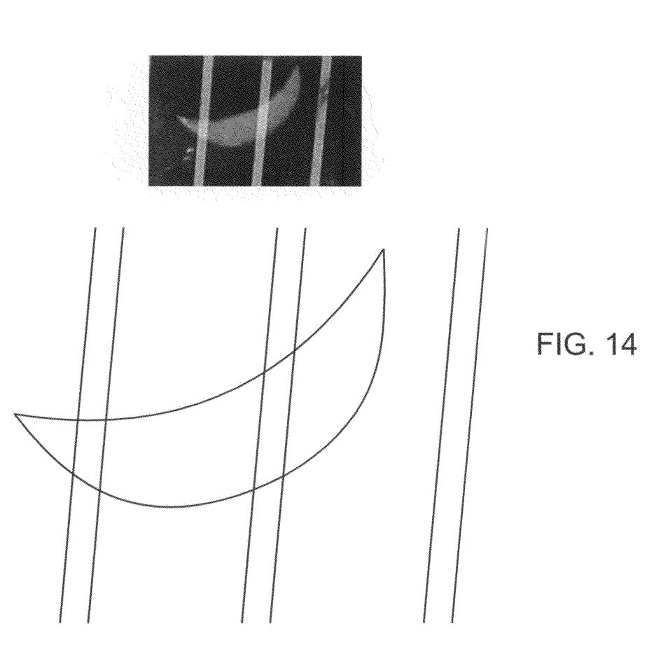

FIG. 14 shows the area of FIG. 12 translated into vector or outline form.

Analyzing the vectors, in terms of length, thickness number of items etc. may bring us to the conclusion that even though the color histogram of the background comprises very few colors, the background itself contains some objects that would need to be taken into consideration while restoring the background behind the moon. The complexity of the background may lead to a decision to cancel the moon's nomination as an object for removal, depending on the installed capability for background restoration.

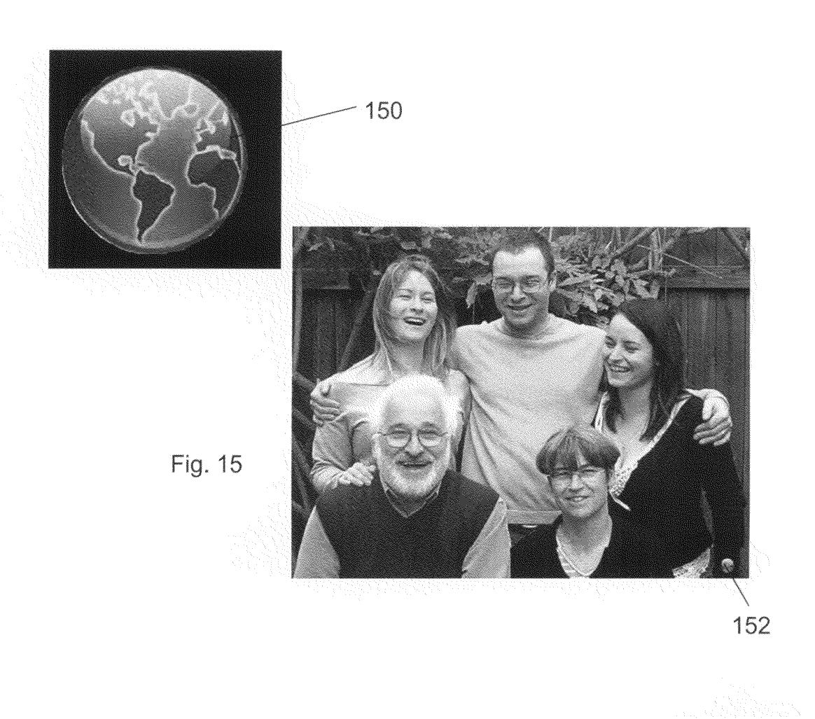

Reference is now made to FIG. 15, which shows a symbol and the insertion of the symbol into a user-provided image. That is to say, instead of subtracting an object from the scene one may add an object to the scene.

The game algorithm can add an object such as a constant symbol or a symbol taken from a list or a symbol chosen at random to the image.

As shown in FIG. 15, an object to be added to the image is the earth icon 150 which is added to the location 152. In fact the application has located a spot in terms of a suitable background and added the earth icon, to the rightmost black sleeve of the girl on the right hand side of the image. In this example, presumably one of the easier levels, no attempt is made to use the background color to conceal the added object, but on higher levels the object may be merged with the color of the black background to make it less visible. Additionally or alternatively the size of the object may be altered to make it easier or harder to find.

Now the user may proceed to use the keys to manipulate a cursor onto the inserted object and win the game.

An advantage of the addition-based method as opposed to the subtraction method is on the algorithm level. Since no object needs to be identified from the image, the addition-based method is easier than the subtraction-based method to implement. The main requirement is minimal background analysis to find a suitable stretch of background to add the object and if desired to color the object to conceal it within the background. As an alternative to finding the color of the background, a transparency level may be set for the background, which merges the object colors with the background colors.

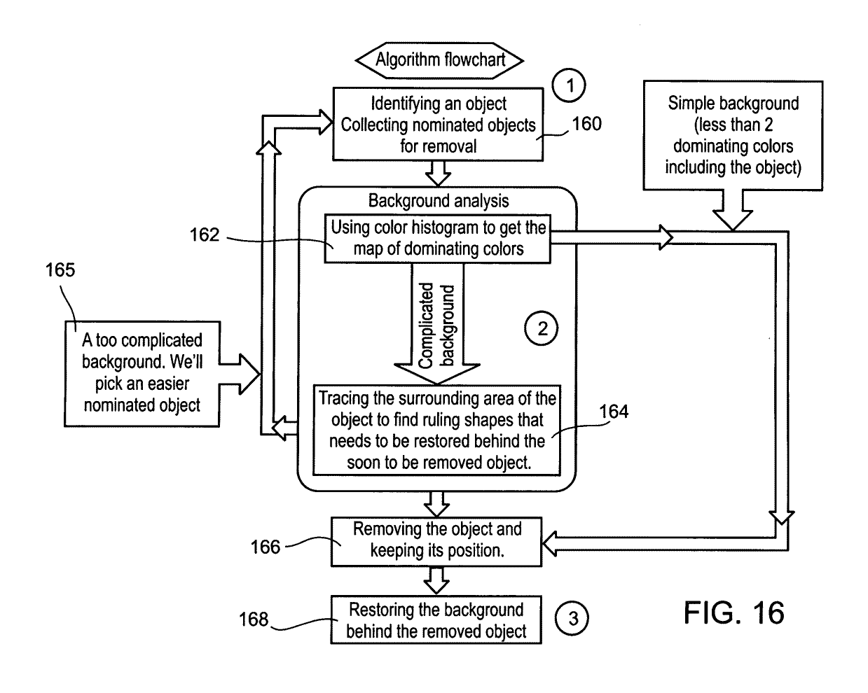

Reference is now made to FIG. 16 which is a more detailed version of the flow chart of FIG. 5, showing the subtracting version of the game.

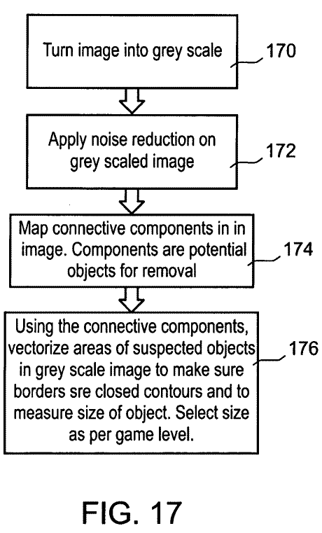

In stage 160, objects are identified. The object identification process is outlined in FIG. 17, below. Objects that are suitable under various criteria such as being of appropriate size, and at least relatively stationary, are nominated for removal.

In stage 162 a background analysis is carried out. A color histogram illustrates the complexity of the background around the nominated object. If the background is simple, just a single color, then flow branches directly to stage 166. If the background is complex then vector analysis is used in stage 164 to delineate objects within the background that may need to be restored if the object is removed. If the background is too complex for safe restoration then box 165 is entered and a new object is looked for as a candidate for removal.

In stage 166 the object is removed and the location of removal is recorded. In stage 168 the object is replaced by its background to give an impression of a continuous background.

Reference is now made to FIG. 17, which is a simplified flow diagram illustrating a procedure for identifying objects. In stage 170 the image is changed into gray scale. Noise reduction is then applied to the grayscale version of the image in stage 172. Suitable noise reduction provides better results in the later stages below.

In stage 174 a map is built of all connective components in the image. That is to say a map is built of regions of pixels with similar color, similarity being measured by a threshold. The groups of pixels making up the connective components are in fact objects that could potentially be removed. Stage 174 may be carried out on the gray level image.

Finally, in stage 176 vector analysis as described above is used to draw borders around the objects, again on the gray level image. The borders can be used to ensure that the objects indicated by the connective components of the previous stage in fact do form closed shapes. The borders further permit measuring of the size of the objects. Levels of difficulty can then be set by choosing objects of a given size.

It is noted that if the user is to compare the altered image to the actual background he or she needs to choose a relatively static scene. The instructions of the game may include a warning to avoid too dynamic a scene. Thus if the algorithm were to remove a moving item from the image such as a moving car, the player would not actually be able to solve the mystery since the removed object might may already have moved away from the actual environment so that no comparison can be made.

Beyond providing the above warning it is also possible to avoid removing moving items because the user may nevertheless take an image of a street or the like which contains many dynamic objects.

Thus, as explained above, while analyzing potential items for removal, it is possible to additionally use a movement indication to disqualify some nominated objects.

In one embodiment, the spot the difference application may be provided in a Panorama version. The procedure is the same as for the regular game but the difference lies in that the image captured is not a single image but a sequence of images giving all round coverage about the user. Existing technologies allow the user to take such a panorama picture. The remainder is the same, but because the user has to scan all around him, the game becomes more difficult and thus more interesting, allowing the user to search for the subtracted/added object.

In another embodiment, the game may have a video version. All the image manipulation processes above are performed in real time, and in terms of video, the application may trace objects across frames and manipulate each frame from the camera and not just a single shot. The user may watch a video stream of the scene in front of him and is challenged to identify missing objects on the run and not on a static single picture as in the other version.

The description above is actually a real time version of a famous and familiar game “spot the differences” but provides the user with the ability to choose the scene for the game and to see a randomly manipulation of a picture he took himself.

It is expected that during the life of a patent maturing from this application many relevant image capture and processing technologies will be developed and the scopes of the corresponding terms are intended to include all such new technologies a priori.

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. Apparatus for image acquiring and modification, comprising:
an image acquiring unit for acquiring an image,
an image localized modification unit configured to make a modification to said acquired image in real time at a given locality,
a modification storage unit, associated with said image localized modification unit, for automatically storing said locality, and
an interaction unit associated with said modification storage register, configured for displaying said image to a user, said interaction unit including pointing interactivity for allowing a user to point to a location on said image, said interaction unit further comprising an indicator to indicate to a user when said location coincides with said locality.

2. Apparatus according to claim 1, wherein said image localized modification unit is configured to make said modification after said acquiring and prior to said displaying.

3. Apparatus according to claim 1, wherein said modification comprises making an addition to said image at said given locality.

4. Apparatus according to claim 1, wherein said modification comprises making a subtraction from said image at said given locality.

5. Apparatus according to claim 4, wherein said modification comprises replacement of said subtraction with a continuation of a background.

6. Apparatus according to claim 1, wherein said modification is applied to an object within said image.

7. Apparatus according to claim 6, further comprising an object identifier for identifying objects within said image as candidates for said modification.

8. Apparatus according to claim 1, wherein said object identifier is associated with a movement detector, said movement detector being configured to use movement detection to prefer relatively stationary objects as targets for said modification.

9. Apparatus according to claim 7, wherein said object identifier is configured to detect boundaries within said image and from said boundaries to infer an object from any closed boundary.

10. Apparatus according to claim 9, wherein said object identifier is configured to infer a boundary from substantial color changes between pixels.

11. Apparatus according to claim 1, wherein said modification is carried out in accordance with input from a user.

12. Apparatus according to claim 7, further comprising a background analyzer, associated with said object identifier, to distinguish those objects lying over a relatively uniform background as preferred candidates for said modification.

13. Apparatus according to claim 3, further comprising a background analyzer for analyzing a background against which said addition is made, thereby to allow said addition to merge into said background.

14. Apparatus according to claim 1, being a mobile communication device wherein said image acquiring unit comprises a built-in camera.

15. Apparatus according to claim 14, wherein said interaction unit comprises a message sending unit for sending said modified image to other users.

16. Apparatus according to claim 1, wherein said interaction unit is configured to show both said modified image and an unmodified original.

17. Apparatus according to claim 16, wherein said interaction unit is configured to assign a user a score based on a number of modifications identified.

18. Apparatus according to claim 1, wherein said interaction unit is configured to assign a score based on a time taken to identify modifications.

19. Apparatus according to claim 14, wherein said interaction unit is configured to retain a connection with another unit to which said image was sent, thereby to enable competition between users.

20. Apparatus according to claim 1, wherein said interaction unit is configured to obtain from a user a number of modifications to be made.

21. Method for image acquiring and modification, comprising:
acquiring an image,
making a modification to said acquired image in real time at a given locality,
storing said locality,
displaying said image to a user,
allowing a user to point to a location on said image,
indicating to a user when said locality coincides with said location.
